(19) United States
(12) Patent Application Publication
(10) Pub. No.: US 2008/0074885 A1
(43) Pub. Date: Mar. 27, 2008

(54) LED LIGHT UNIT

(76) Inventors: David C. Brands, Portland, OR (US); Richar Yee, Yangjiang (CN); Rainer Opolka, Solingen (DE)

Correspondence Address: KOLISCH HARTWELL, P.C., 520 SW YAMHILL STREET, Suite 200, PORTLAND, OR, 97204, US

(21) Appl. No.: 11/469,341

(22) Filed: Aug. 31, 2006

(51) Int. Cl. F21V 7/00; F21V 8/00

(52) U.S. Cl. 362/296; 362/257; 362/311

(57) ABSTRACT

A lighting unit is provided including at least one LED, a plug for connecting the unit to an appliance and a light emitting element. The lighting unit may include electronic components to condition power from the appliance. The light emitting element may comprise a reflector where the LED emits light into the reflector and the light is collimated by the reflector and emitted from the unit. The position of the LED may be adjustable so the LED moves closer or farther from the reflector. Light is emitted from the unit in a narrower or wider beam in response to moving the LED. Alternately, the light emitting element may be an optical waveguide with a receiving end proximate to the LED emitting face and an emitting face away from and opposite the receiving face. The optical waveguide may collimate the wide angle of light emitted by the LED to form a narrow, directed beam.

### FIELD OF THE INVENTION

The present invention relates to light units using light emitting diodes (LEDs) as the light source, which may be used to replace halogen, incandescent or fluorescent bulbs.

### BACKGROUND OF THE INVENTION

New high intensity LEDs have adequate light intensity and illumination to replace existing lighting, such as fluorescent, halogen and incandescent bulbs, while decreasing package size and power consumed. New high brightness LEDs use a more powerful chip to generate a much brighter light. Manufacturers are producing high brightness LED packages in a variety of forms. Originally these LEDs were directly substituted for standard incandescent bulbs. LEDs emit light from a plane rather than radiating omnidirectionally from an incandescent filament. The included angle of the light from an LED is much narrower than an incandescent bulb, but it is still not sufficiently narrow to form a beam, and the intensity of the light diminishes quickly with distance.

Halogen, fluorescent and incandescent bulbs have used parabolic reflectors to direct and shape the light beam, and lenses to focus the beam. The conditioning of the emitted light was less complicated with sources such as incandescent bulbs, because the light source could be placed at the focal point of the parabolic reflector to get a focused beam. It is more difficult to get the apparent emitted light to appear at the focal point with a planar light source. LED units have employed a number of methods in order to use reflecting surfaces and focus a beam. One method reflects the LED light from a second mirror at the focal point into the focusing mirror. Yet another method uses a cylindrical reflector that directs the beam.

Typically in light bulbs with directed or shaped beams, the intensity of the light in the beam is not uniform across the beam. This results in lighter and darker areas in the illuminated field. Some bulbs may also create a beam with an irregular shape.

The optimal LED unit emits virtually all of the light from the LED into an optimally sized area with a fairly narrow angle. By so doing, light intensity and illumination are not diminished with distance from the viewer. The light should also be relatively uniform across the illuminated area. Optionally, it should be possible to adjust the width of the beam to meet a range of lighting requirements.

### SUMMARY OF THE INVENTION

A light emitting diode lighting unit is provided with a configuration, physical dimensions and performance characteristics that allow it to replace existing bulbs using less efficient light generation technologies. The unit may be configured to replace halogen, incandescent, fluorescent or other bulbs. The plug or connector may be sized to plug into a socket with a G4, G6.35, G8, G10 or other form factor socket.

A first embodiment of a light emitting diode (LED) unit includes a near end and a distal end spaced apart and a central axis passing through the near end and distal end. The unit is configured to separably connect to an appliance with a socket. The LED unit includes a lamp housing, a plug at the near end with a plurality of exposed terminals configured to mate with the appliance socket, a reflector, substantially transverse to the central axis, configured to emit light at the distal end. The unit also includes an LED assembly oriented with the central axis, that has an LED with a luminescent front portion and operably connected to the plurality of exposed terminals, and an LED mount supporting the LED and orienting the LED to emit light into the reflector. The unit has at least one support with a near end and a distal end. The support is connected to the lamp housing at the near end and the LED assembly at the distal end.

In a similar configuration of the first embodiment, an LED lighting system comprises an appliance that includes a socket and a lighting unit. The lighting unit includes a housing, a slidable LED, a curved reflector disposed opposite the LED for collimating light from the LED, a plug for mating to the appliance socket including terminals and a power supply for modifying power from the appliance.

A second embodiment of an LED unit is configured to separably connect to an appliance at a socket. An example of the unit includes a housing supporting at least one LED having a luminescent front portion, a plug with a plurality of terminals configured to mate to the appliance socket and an optical waveguide with a near end and a distal end. The near end of the waveguide is positioned immediately adjacent the front portion of the at least one LED to at least partially collimate and reemit the light at the distal end.

A similar configuration is an LED lighting system which includes an appliance with a socket and a lighting unit. The lighting unit includes a housing, an LED, a transparent light guide for collimating light emitted by the LED, a plug for mating to the appliance socket including terminals and a power supply for modifying power from the appliance.

The LED unit power supply electronics condition or convert the power supplied at the appliance socket to a voltage and waveform compatible with the LED. Power conditioning may include rectifying the voltage from alternating cycle to a half-wave or direct current cycle and/or changing the voltage magnitude. For some configurations, no power supply electronics are required.

The light guide or waveguide is formed of solid, transparent material having a first end positioned immediately adjacent the front portion of the LED. A second end of the light guide is positioned remotely from the LED. The first end of the light guide receives light from the LED and the second end of the light guide emits light that passes through the light guide.

In configurations with a reflector, the LED may be disposed in front of or opposite the reflector and emits light into the reflector. The reflected light that is emitted from the lighting unit travels in a reverse direction from the light emitted from the LED. A lens in front of the LED emitting face may partially focus the LED light to direct more light into the reflector.

### BRIEF DESCRIPTION OF THE DRAWINGS

FIG. 1 is a perspective view of an LED lighting unit replacing a conventional bulb in a lighting appliance.

FIG. 2 is a side elevation sectional view of a first embodiment of the present invention including a reflector.

FIG. 3 is a side exploded perspective view of an LED light unit of the embodiment of FIG. 1.

FIG. 4 is a side elevation sectional view of a second embodiment of the present invention including a light guide.

FIG. 5 is a perspective view of an LED including a substrate and an emitter face.

FIG. 6 is a side elevation sectional view of the light guide of the embodiment of FIG. 4.

FIG. 7 is a side exploded perspective view of the embodiment of FIG. 4.

### DETAILED DESCRIPTION OF THE PREFERRED EMBODIMENTS

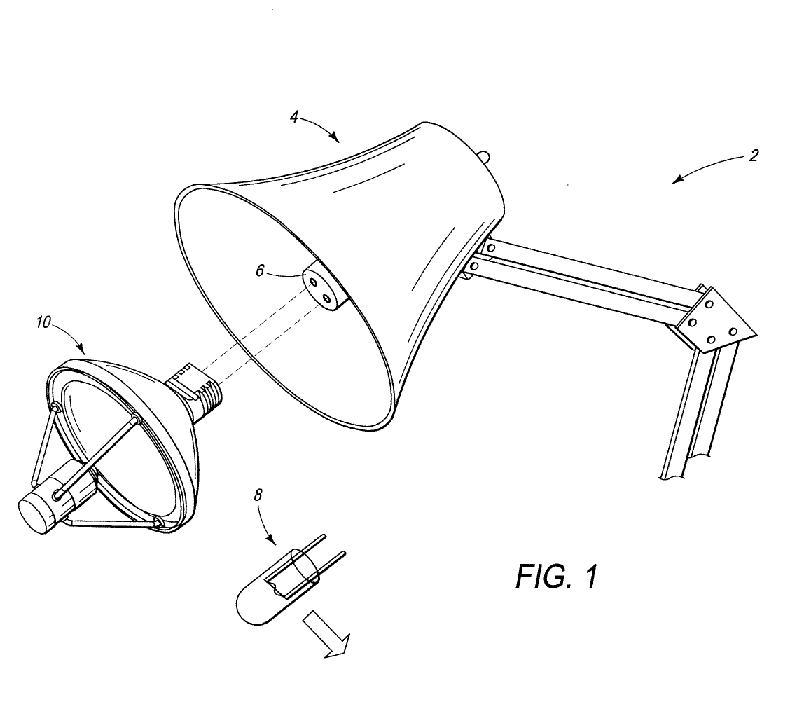

FIG. 1 shows the replacement of a bulb in an appliance generally identified by the number 2. An appliance 4, with a socket 6 for mounting a bulb is shown. A conventional bulb 8 is removed and is being replaced with an LED lamp or unit 10 to reduce power consumption and heat generation by the appliance. LED unit 10 generally includes a light emitter to collimate light from the LED light source. Appliance 4 may be an arm lamp, a puck light, track lighting or a similar lighting device that may use a halogen, incandescent, fluorescent or other bulb with less efficient lighting characteristics than LED lighting unit 10.

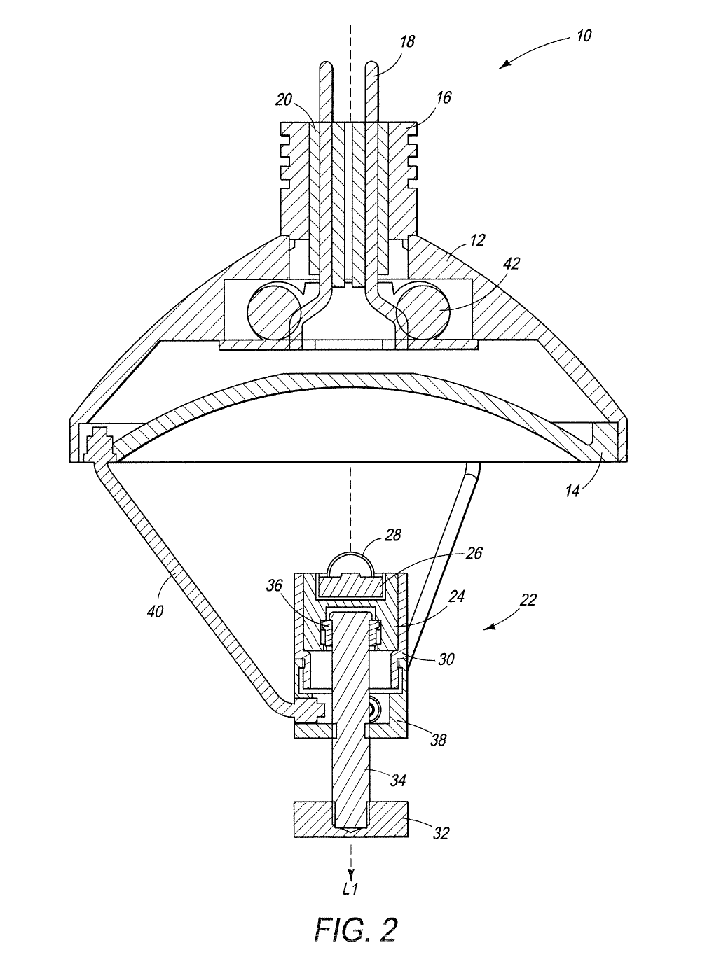

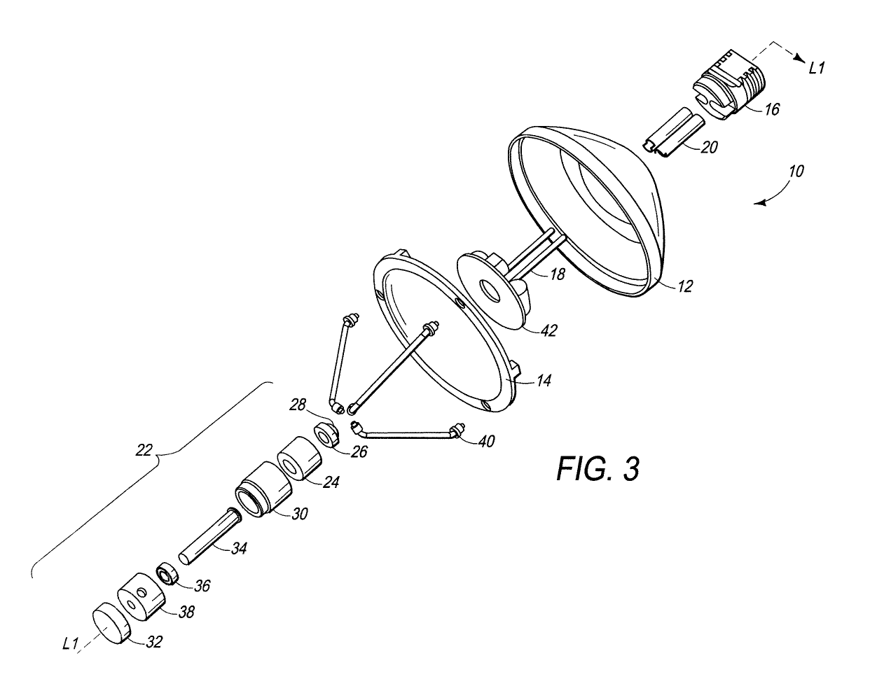

A first embodiment of LED unit 10 is shown best in FIGS. 2 and 3. Referring first to FIG. 2, a side cross section view of unit 10 in a first embodiment shows a lighting unit housing 12 which supports a light emitter in the form of reflector 14, and a plug base 16 which retains connector pins 18 and an insulator 20.

Housing 12 also supports LED assembly 22 comprising LED base 24 which holds LED 26 including LED lens 28, sheath 30, screw knob 32, screw 34, collar 36 and assembly member 38. LED assembly 22 is connected to unit housing 12 and is supported opposite reflector 14 by one or more leg 40. Leg 40 is secured at a first end to LED assembly member 38 and at a second end to unit housing 12. LED assembly 22 is supported by leg 40 so the emitting face of LED 26 in LED base 24 emits light into reflector 14. LED base 24 with LED 26 is also slidably mounted in sheath 30 which is secured to assembly member 38. LED unit 10 has a longitudinal axis L1 and the components of LED assembly 22 are assembled generally along the longitudinal axis L1.

LED base 24 holds LED 26 in a first end. At a second and opposite end of LED base 24 is a bore. Collar 36 is retained in the bore at an outside circumference of collar 36. Collar 36 retains a first end of screw 34 at an inside circumference. Screw 34 can rotate in collar 36 freely, but has limited motion along the screw length. LED base 24 slides in sheath 30 in operative relation to screw 34. At a second end of screw 34, knob 32 is sized to manually turn the screw. Between the first and second ends, screw 34 passes through a threaded hole in assembly member 38.

LED 26 and base 24 slide longitudinally in sheath 30 as screw 34 rotates in the threaded hole of assembly member 38. Screw 34 moves in and out of member 38 longitudinally. LED 26 also moves in relation to the focal point of reflector 14. The beam emitted by LED unit 10 widens or narrows in response to sliding movement of LED 26 and base 24 in sheath 30.

This is an example for illustration purposes only and should not be considered a limitation. LED assembly 22 may have a different configuration than that shown. LED assembly member 38 and sheath 30 could be a single unit. Screw 34 could be linked to LED base 24 without collar 36 and still be within the scope of this disclosure. The position of LED 26 may be adjusted by other means than screw 34.

Unit housing 12 may support power supply electronics 42. LED 26 may require a different power than the power supplied by appliance 4 connected to unit 10. Power supply 42, where required, conditions the power supplied by appliance 4 to make it compatible with LED 26. For example, power supply 42 may change the voltage from 120 volts to 12 volts. Power supply 42 may change alternating current to direct current. Electrical power is supplied to LED 26 through leg 40.

Reflector 14 has an outward facing concave surface when assembled into unit housing 12. The concave surface has a highly polished or reflective face. The concave face may form a parabolic curve and is configured to collimate light from LED 26 and emit it as a narrow beam.

FIG. 3 is an exploded view of LED unit 10 of FIG. 2. LED unit 10 again includes unit housing 12 which supports reflector 14, and plug base 16 which retains connector pins 18 and insulator 20, LED assembly 22 which includes LED base 24, LED 26, sheath 30, knob 32, screw 34, threaded collar 36 and assembly member 38 and one or more legs 40.

Pins 18 and insulator 20 assemble in plug base 16 which is assembled to unit housing 12. Power supply electronics 42 are assembled into unit housing 12, and are operably connected to pins 18, which supply power to electronics 42. Reflector 14 is assembled to unit housing 12, covering and enclosing power supply 42.

LED 26 with LED lens 28 and collar 36 are assembled to LED base 24. Collar 36 in base 24 also retains a first end of screw 34. Assembled LED base 24 slides into sheath 30, which is assembled to assembly member 38. Screw 34 is screwed into the threaded hole on the longitudinal axis L1 of assembly member 38. Knob 32 is fixed to, or formed in the second end of screw 34. A first end of leg 40 is attached to LED assembly member 38 and a second end of leg 40 is attached to unit housing 12 to support LED assembly 22 above reflector 14. Leg 40 may comprise more than one member.

Plug base 16 may have terminals configured to connect to other socket form factors than those with pins. Plug base 16 may be configured with a first terminal with threads and a second terminal acting as a pressure contact. This plug base is similar to a screw in light bulb and may be sized to existing standards.

In an alternate configuration of the first embodiment, LED assembly 22 may support a plurality of LEDs in LED base 24. In another alternate configuration, LED 26 may not be movable in LED assembly 22 and may be fixed in place.

### Embodiment of FIGS. 4-7

FIG. 4 is a cross section side view of a second embodiment of an LED unit shown generally as 50. In this embodiment, the light emitter is a substantially conical light guide made from a translucent plastic or other light permeable material. The phrase “substantially conical” is intended to cover a perfectly conical shape as well as one that is somewhat rounded as shown in FIG. 4.

For clarity, similar numbering may be used in this and later figures as was used in previous figures. LED unit 50 again includes a unit housing 12, a plug base 16 retaining plug pins 18 and insulator 20, an LED 26 operably connected to plug pins 18. LED unit 50 may further include a power supply 42 and a support frame 52 configured to align and support internal components, a light guide 54 and a front cover 56. LED 26 may be mounted on and supported by power supply 42.

As depicted in FIG. 4, power supply electronics 42, support frame 52, LED 26 and elongated, substantially conical light guide 54 assemble into unit housing 12. Front cover 56 may form an annular ring. Front cover 56 assembles to unit housing 12 and may include a stepped hole or a retaining lip 58 on the inside circumference to retain the light guide. The unit housing is normally internally threaded to receive front cover 56.

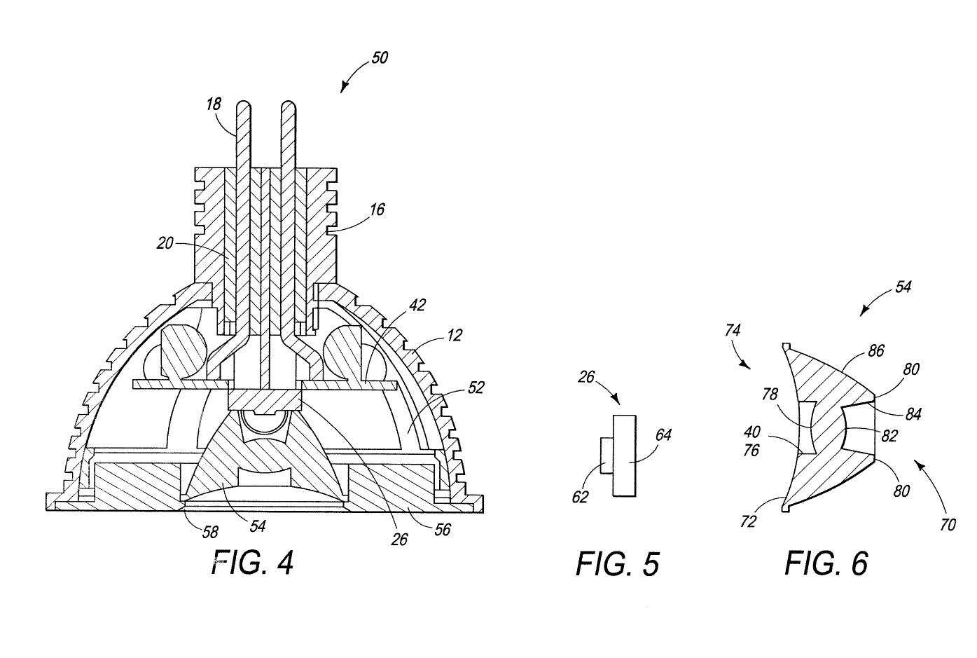

FIG. 5 is a side view of LED 26. LED 26 typically comprises LED emitter 62 on a substrate 64 which extends laterally beyond LED emitter 62.

FIG. 6 is a side cross section view of light guide 54. Light guide 54 may be manufactured from a single piece of material formed in the desired shape. Light guide 54 may be formed of a transparent, rigid material, with a high index of refraction such as glass, Plexiglas or other polymer. As depicted in the same figure, light guide 54 generally includes an admitter face 70, a first emitter face 72, a hole 74 in emitter face 72, and a side wall 76 and a second emitter face 78 forming the bottom of hole 74. Side wall 76 extends between first emitter face 72 and second emitter face 78.

Admitter face 70 typically includes three faces. The first face, which shall be referred to as an annular base 80, is in the general configuration of an annular ring. In the depicted embodiment, annular base 80 contacts LED substrate 64 when annular base 80 is assembled into unit housing 12. The second face shall be referred to as a protrusion 82 facing LED emitter 62. The third face shall be referred to as an interior face 84. Interior face 84 extends from annular base 80 to protrusion 82.

Protrusion 82 and emitter face 78 may be curved as shown to form hemispheres, but may have other shapes to form faces of different configurations. Side wall 86 may form a generally parabolic surface as shown in the preferred embodiment of FIG. 6. Side walls 86 may have straight sides to form a generally cylindrical or a generally conical shape (not shown).

Light guide 54 may not include hole 74 in emitter face 72. Emitter face 72 may be a smooth and continuous surface.

A well known property of light guide 54 is that the light exiting the light guide at emitter faces 72 and 78, where the light guide is sufficient in length, will be relatively uniform in brightness. This relatively uniform brightness is due to the mixing within light guide 54 due to multiple reflections within the light guide.

Referring again to FIG. 4, light guide 54, when assembled, is operatively coupled to LED 26. Light guide 54 is designed to admit all of the light from LED 26, and emit the light as a substantially collimated beam from emitter faces 72 and 78 with relatively uniform brightness. Light guide 54 may include a protruding key (not shown) on sidewall 86 which may align light guide 54 to unit housing 12 or front cover 56.

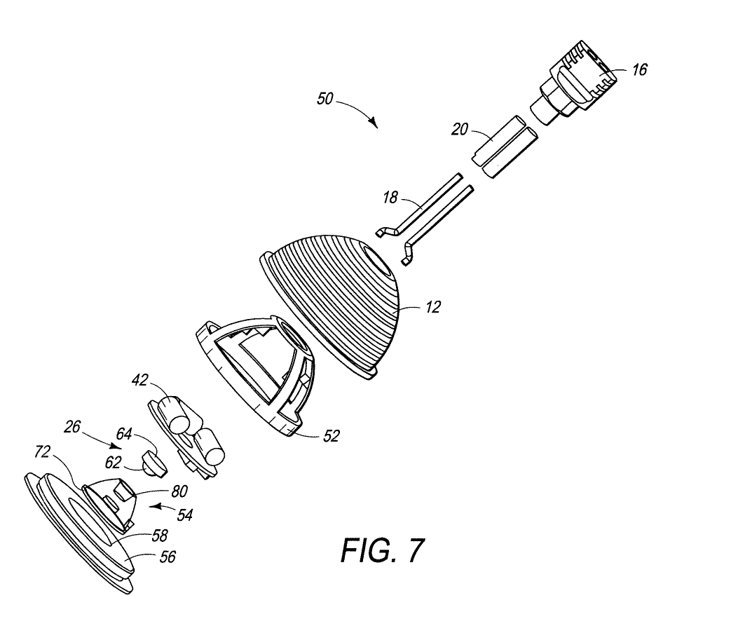

FIG. 7 is a side perspective exploded view of LED unit 50 of FIG. 4. LED unit 50 again includes unit housing 12, plug base 16 which supports connector pins 18 and insulator 20, LED 26, power supply 42, support frame 52, light guide 54, and front cover 56. Pins 18 and insulator 20 assemble in plug base 16 and are assembled to unit housing 12. Power supply electronics 42 and support frame 52 are assembled into unit housing 12 and are operably connected to pins 18 which supply power to electronics 42. LED 26 is assembled to power supply electronics 42.

Admitter face 70 of light guide 54 is assembled over LED 26 so annular base 80 contacts substrate 64. Front cover 56 is assembled to unit housing 12. Primary emitter face 72 seats on retaining lip 58. Light guide 54 is held between lip 58 and LED substrate 64. In an alternate configuration (not shown), annular base 80 has an inside diameter larger than the LED substrate 64. In this configuration, annular base 80 abuts a flat surface of power supply electronics 42, and LED 26, including substrate 64, is seated into admitter face 70.

Again referring to FIG. 6, as an example only, emitter face 72 of light guide 54 is 25 mm in diameter. Admitter face 70 is 9 mm in diameter at the outside of annular base 80, and 5.6 mm at the inside of the annular base. Protrusion 82 may be a hemisphere, with a base that is 4 mm in diameter. The distance from the plane through the rim of emitter face 72 to annular base 80 is 19.3 mm. The diameter of LED emitter face 62 is 5.5 mm. In this depicted embodiment, the top of LED emitter face 62 is 4.6 mm above LED substrate 64, with the top of hemispheric protrusion 82 being 14.6 mm below annular base 80. When assembled, this provides a 0.1 mm clearance between the hemispheric protrusion 82 and LED emitter 28. Hole 74 may be 11.2 mm deep and 5 mm in diameter. Light guide wall 86 forms a generally parabolic curve.

Light guide 54 may be configured to accommodate a plurality of LEDs 26. Annular base 80 may be wide enough to encompass multiple LEDs in admitter face 70. Alternately, light guide 54 may have multiple admitter faces 70 in one light guide 54 such that each of multiple LEDs 26 has an annular base 80 and a protrusion 82 to admit light to the light guide.

Lighting unit structural components such as unit housing 12, plug 16, LED assembly 22 and front cover 56 may be made from a metal such as aluminum or steel or a plastic such as ABS. Component materials may be selected to be compatible with lighting unit operation in harsh environments such as very high or very low ambient temperatures.

Although the invention has been described in detail for the purpose of illustration, it is to be understood that such detail is solely for that purpose, and variations can be made therein by those skilled in the art without departing from the spirit and scope of the invention, except as it may be limited by the claims.

Applicants regard the subject matter of their invention to include all novel and non-obvious combinations and subcombinations of the various elements, features, functions and/or properties disclosed herein. No single feature, function, element or property of the disclosed examples is essential to all examples. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicants' invention.

1. A light emitting diode (LED) unit, with a near end and a distal end spaced apart and a central axis passing through the near end and distal end, configured to separably connect to an appliance with a socket, the LED unit comprising:
a lamp housing including:
a plug at the near end with a plurality of exposed terminals configured to mate with the appliance socket; and
a reflector substantially transverse to the central axis configured to emit light at the distal end;
an LED assembly, oriented with the central axis, including:
an LED having a luminescent front portion and operably connected to the plurality of exposed terminals; and
an LED mount supporting the LED and orienting the LED to emit light into the reflector; and
at least one support with a near end and a distal end, the support connected to the lamp housing at the near end and the LED assembly at the distal end.

2. The light emitting diode unit of claim 1 where the LED mount is slidably mounted in the LED assembly.

3. The light emitting diode unit of claim 2 where the LED assembly includes a threaded shaft in a threaded aperture and the LED mount slides in the LED assembly in response to rotation of the threaded shaft.

4. The light emitting diode unit of claim 1 where the plurality of exposed terminals are pins with a center to center distance between the pins of 4 mm, 6.35 mm, 8 mm, 10 mm or 16 mm.

5. The light emitting diode unit of claim 1 where the plurality of exposed terminals form a screw base with a first threaded terminal and a second pressure contact terminal.

6. The light emitting diode unit of claim 1 further comprising a power supply configured to increase or decrease the level of a voltage supplied to the terminals at the appliance socket.

7. The light emitting diode unit of claim 1 further comprising a power supply configured to rectify an alternating current supplied to the terminals at the appliance socket.

8. A light emitting diode unit configured to separably connect to an appliance at a socket, the LED unit comprising:
a housing supporting:
at least one LED having a luminescent front portion;
a plug with a plurality of terminals configured to mate to the appliance socket; and
an optical waveguide with a near end and a distal end, the near end positioned immediately adjacent the front portion of the at least one LED, to at least partially collimate and reemit the light at the distal end.

9. The light emitting diode unit of claim 8 where the plurality of terminals are pins and a center to center distance between the pins is 4 mm, 6.35 mm, 8 mm, 10 mm or 16 mm.

10. The light emitting diode unit of claim 8 where the plurality of terminals are configured as a screw base with a first threaded terminal and a second pressure contact terminal.

11. The light emitting diode unit of claim 8 further comprising a power supply supported by the housing, operably connected to the plurality of terminals and configured to decrease a voltage supplied to the unit at the terminals.

12. The light emitting diode unit of claim 8 where the waveguide is Plexiglass.

13. The light emitting diode unit of claim 8 where the waveguide includes at least one bore at the near end to admit the at least one LED.

14. A light emitting diode lighting system comprising:
an appliance including a socket; and
a lighting unit including:
a housing;
an LED;
a transparent light guide for collimating light emitted by the LED;
a plug for mating to the appliance socket including terminals; and
a power supply for modifying power from the appliance.

15. The lighting system of claim 14 where the power supply modifies a voltage level supplied by the appliance.

16. The lighting system of claim 14 where the power supply rectifies an alternating current supplied by the appliance.

17. The lighting system of claim 14 where the terminals are two pins with a center to center distance between the pins of 4 mm, 6.35 mm, 8 mm, 10 mm or 16 mm.

18. The lighting system of claim 14 where the terminals are a pressure contact and a threaded conductor configured as a screw in plug.

19. A light emitting diode lighting system comprising:
an appliance including a socket; and
a lighting unit including:
a housing;
a slidable LED;
a curved reflector disposed opposite the LED for collimating light from the LED;
a plug for mating to the appliance socket including terminals; and
a power supply for modifying power from the appliance.

20. The lighting system of claim 19 where the LED is operably connected to a threaded shaft and slides in response to rotation of the threaded shaft in a threaded aperture.

21. The lighting system of claim 20 where light is emitted from the lighting unit in a wider or narrower beam in response to sliding the LED.

22. The lighting system of claim 19 where the power supply modifies a voltage level supplied by the appliance.

23. The lighting system of claim 19 where the power supply rectifies an alternating current supplied by the appliance.

24. The lighting system of claim 19 where the terminals are two pins with a center to center distance between the pins of 4 mm, 6.35 mm, 8 mm, 10 mm or 16 mm.

25. The lighting system of claim 19 where the terminals are a pressure contact and a threaded conductor configured as a screw in plug.
